(19) United States
(12) Patent Application Publication
(10) Pub. No.: US 2026/0242609 A1
(43) Pub. Date: Aug. 20, 2026

(54) Effect Pigments with Sparkle

(71) Applicants: Sun Chemical B.V., Weesp (NL); SUN CHEMICAL CORPORATION, Parsippany, NJ (US)

(72) Inventors: Steven JONES, Tarrytown, NY (US); William HICKLING, Peekskill, NY (US); Renee BARNEY, Peekskill, NY (US); Raimund SCHMID, Ludwigshafen am Rhein (DE)

(73) Assignees: Sun Chemical B.V., Weesp (NL); Sun Chemical Corporation, Parsippany, NJ (US)

(21) Appl. No.: 19/482,720

(22) PCT Filed: Jul. 18, 2023
(86) PCT No.: PCT/EP2023/069908

§ 371 Date: Nov. 7, 2025

(30) Foreign Application Priority Data
Dec. 7, 2022 (EP) 22185750.1

(51) Int. Cl. C09C 1/00; C09D 5/36; C09D 7/62; C09D 11/037

(52) U.S. Cl. CPC C09C 1/0051; C09D 5/36; C09D 7/62; C09D 11/037; C01P 2004/20; C01P 2004/86; C01P 2006/62; C01P 2006/65; C01P 2006/66; C09C 2200/102; C09C 2200/302; C09C 2200/303; C09C 2220/106

(57) ABSTRACT

Effect pigments based on transparent platy substrates containing a near refractive index layer coating that is near the refractive index of the substrate, thus effectively increasing the thickness of the substrate to produce higher sparkle.

Sparkle effects are used since many decades as design element in industrial design. Sparkling effects are attracting attention in cosmetic applications, packaging, printing inks and all types of coatings. Technically sparkling effects are generated by incorporating small, light reflecting flakes with diameters of about 5-1000 μm in coatings of surfaces or as mass coloration of plastics or cosmetic powders.

In industrial coatings there are some restrictions with regard to particle-sizes and thicknesses. The reason for that is, that coatings after drying are significantly thinner than 50 μm. For example, in automotive coatings, modern basecoats are below 20 μm in thickness. The resulting requirement for sparkling pigments is, that they should be small enough in order to allow smooth basecoats with high gloss and at the same time strong in sparkle.

Glass flake based effect pigments show strong sparkle. Especially oxide coated glass flakes with 50-250 μm in diameter and thicknesses of 1-5μ show the desired effects. However, due to the big particle sizes, automotive basecoats are not feasible with these flakes. Smaller (below 20 μm) and thinner (below 500 nm) glass flakes as substrates have been tested, however so far their reproducibility in terms of thickness- and shape-variations in production scale was poor.

More successful substrates were Al₂O₃-flakes, which were synthesized in an expensive crystallization process. Such flakes are after coating with iron oxide or titanium oxide very uniform in size (D50=15-20 μm) and very smooth. They give excellent reflection of light and found wide use in automotive basecoats. However, the high cost and the abrasiveness of Al₂O₃-flake-based pigments created a market demand for more cost efficient solutions. Especially the abrasiveness of Al₂O₃ requires in paint shops more expensive equipment, which withstands the harsh abrasive conditions of paints based thereon.

Mica-based effect pigments with similar particle sizes give only moderate sparkle effects compared to Al₂O₃-flake-based effect pigments. The use of synthetic mica as base for effect pigments allowed increased sparkling performance, because synthetic mica has a more smooth surface quality compared to natural mica. But still, the sparkling performance of synthetic mica-based effect pigments is not yet as strong as with Al₂O₃-flakes. For that reason, intense research was done by the inventors with the target to boost the sparkle of flakes selectively without compromising in applicability in thin basecoats.

Surprisingly it was found, that the sparkle effect of any oxide coated flakes can be tuned by applying an inorganic coating with a near refractive index directly on top of given flakes followed by coatings with high refractive metal oxides. That finding was so far not disclosed in the state of the art.

U.S. Pat. No. 10,214,651B1 relates to effect pigments for use with a frit, wherein the effect pigment comprises a substrate coated with a variety of layers, including the option of the first layer being a low refractive index layer selected from the group Al₂O₃, SiO₂, zirconium silicate ZrSiO₄, mullite 3Al₂O₃×2SiO₂ or 2Al₂O₃×SiO₂ (sintered or fused mullite) or alkaline-earth metal silicate (MSiO₃, where M is Mg²⁺, Ca²⁺, Sr²⁺ or Ba²⁺, or M₂Si₃O₈, where M is Mg²⁺, Ca²⁺, Sr²⁺ or Ba²⁺). Details of the first low refractive index layer or its purpose are not disclosed.

U.S. Pat. No. 7,699,927B1 provides a protective layer for an effect pigment which includes a SiO₂ layer. The thickness of the SiO₂ is between 2 and 20 nm or between 0.5 and 10 wt % of the pigment. These effect pigments do not produce a sparkle effect.

CN108165053A provides a high chroma anatase effect pigment, which is achieved with a high-low-high refractive index stack. There is an additional silica layer on the mica prior to the optical layers but purpose of it is not entirely clear. The amount of silica in that initial layer is 0.01 to 2 wt %, which therefore does not produce a sparkle effect.

U.S. Pat. No. 7,485,183B1 discloses blends of commercially available pigments including a glass flake-based effect pigment with various coatings, which may comprise a silica layer between the glass flake and the other coating layers. The purpose of the silica layer is not disclosed.

U.S. Pat. No. 8,883,879B1 relate to making pigment granules which have effect pigments adhered to a support material. Effect pigments known in the art are used, including effect pigments comprising glass flakes as a substrate. The glass flakes-based effect pigments can also have a silica layer between the glass flake and the coatings. The purpose of the silica layer is to protect the glass flake against leaching-out during wet-chemical coating.

U.S. Pat. No. 8,500,901B1 discloses interference pigments based on substrates of aluminum oxide and glass flakes. The stated purpose of the silica layer is to provide silver-white interference pigments having high gloss (L value) and chroma (tinting strength C*) as well as mechanical stability. The gloss mentioned therein is in the sense of the lightness (L value) and relates to the CIELab system and a multi angle color measurement. The principle is, that the angle dependent reflectance is measured in the visible range and coloristical data like C*, L*, h, a, b are mathematically derived.

U.S. Pat. No. 10,597,544B1 relates to effect pigments based on typical substrates, glass flakes are preferred, having eight coating layers, the first of which is silica. The stated purpose of the silica coating is that it protects the glass surface against chemical modification, such as swelling, leaching-out of glass constituents or dissolution in the aggressive acidic coating solutions.

EP2917285A1 relates to multilayer coated effect pigments with at least 4 oxide layers and an optional first SiO₂ layer. The thickness of the SiO₂ layer is 3-150 nm. Main purpose of that layer is to protect glass flake substrates against chemical attack and optionally include carbon black for increased hiding. The next layer is also a low refractive index layer with a thickness of 1-50 nm. A clear purpose of that layer is not described.

U.S. Pat. No. 8,268,069B1 elates to glass flakes coated with various layers and an optional first layer comprising a SiO₂ coating. The purpose of the silica coating is to protect the glass surface against chemical modification, such as swelling, leaching-out of glass constituents or dissolution in the aggressive acidic coating solutions.

While the listed references patents mention some type of low refractive index layer on the substrate before subsequent optical layers, there is no description where the purpose of such a layer is to increase the effective thickness of the substrate and a resulting effect pigment with increased sparkle.

Small particle size substrates, especially thin ones, do not provide for much sparkle when converted into an effect pigment by coating with various optical layers. To increase the sparkle of an effect pigment based on a small particle size substrate, a near refractive index matched layer is applied to the substrate before the optical layers are applied, thus making the substrate essentially thicker and resulting in more sparkle.

Citation or identification of any document in this application is not an admission that such represents prior art to the present invention.

The present invention is drawn to effect pigments based on transparent platy substrates with a coating that is near refractive index matched to the substrate, thus effectively increasing the thickness of the substrate, followed by any combination of optical layers. In one embodiment, the substrates are in the mica group of minerals, for example muscovite is natural mica and fluorophlogopite is synthetic mica. Other types of transparent platy substrates include glass flakes, SiO₂, Al₂O₃, BIOCI, kaolin, ZnO, BN, and perlite. In one embodiment the near refractive index coating would have a refractive index within 0.3 of the substrate and can comprise any material or combination of materials that provide the desired refractive index. Examples of materials for the near refractive index matched coating include, but are not limited to SiO₂, Al₂O₃, and MgO. Also, two or more metal oxides can be mixed to create a desired refractive index matched layer using the following formula

$$n = {X}_{A} \cdot {n}_{A} + {X}_{B} \cdot {n}_{B}$$

Where n is the resulting refractive index of the blend, X_{A} is the mole fraction of component A, n_{A} is the refractive index of component A, X_{B} is the mole fraction of component B, and n_{B} is the refractive index of component B. Table 1 contains a list of relevant materials and literature values for refractive index. Table 2 gives some examples of some blends that can be used to match the refractive index of mica.

TABLE 1
Relevant materials and refractive index

| Material | Refractive Index |
|---|---|
| SiO₂ | 1.46 |
| MgO | 1.736 |
| Al₂O₃ | 1.765 |
| SnO₂ | 1.997 |
| ZnO | 2.008 |
| Mica | 1.60 |

TABLE 2
Metal oxide blends that match refractive index of mica

| A | X_{A} | B | X_{B} |
|---|---|---|---|
| SiO₂ | 0.54 | Al₂O₃ | 0.46 |
| SiO₂ | 0.74 | SnO₂ | 0.26 |
| SiO₂ | 0.49 | MgO | 0.51 |
| SiO₂ | 0.74 | ZnO | 0.26 |

The expression “a near refractive index coating that is matched to the substrate” means that the near refractive index coating has a refractive index within 0.3 of the refractive index of the one or more transparent platy substrate.

The expression “thickness” of a coating refers to the physical thickness of the coating.

While the near refractive index matched coating can be applied to substrates of any size, since substrates with larger particle size distribution (PSD) inherently have more sparkle, it is more practical to apply to smaller substrates, such as those with a Dv50 (average particle size) less than 30 microns. The near refractive index matched coating can be applied by any method, including for example aqueous precipitation, sol-gel and CVD. Prior to applying additional optical layers, if desired, the applied near refractive index coating can be calcined. The subsequent optical layers can include TiO₂, Fe₂O₃, TiO₂/Fe₂O₃, TiO₂/SiO₂/TIO₂, TiO₂/SiO₂/Fe₂O₃, Fe₂O₃/SiO₂/TiO₂, and Fe₂O₃/SiO₂/Fe₂O₃. The increased sparkle of these effect pigments can be measured with a BYK-mac spectrophotometer and compared to effect pigments with equivalent optical layers on equivalent substrates without the initial near refractive index matching coating.

The use of the near refractive index matched coating increases the substrate thickness to increase the sparkle of the resultant effect pigment and provides small PSD. One particular end-use application is automotive coatings where a sparkle effect is often desired but large particle size pigments can't be used.

The present invention is further illustrated by the following set of numbered embodiments and combinations of embodiments resulting from the dependencies and back-references as indicated. In particular, it is noted that in each instance where a range of embodiments is mentioned, for example in the context of a term such as “The composition of any one of paragraphs 1 to 5”, every embodiment in this range is meant to be explicitly disclosed for the skilled person, i.e. the wording of this term is to be understood by the skilled person as being synonymous to “The composition of any one of paragraphs 1, 2, 3, 4 and 5”. Further, it is explicitly noted that the following set of embodiments is not the set of claims determining the extent of protection, but represents a suitably structured part of the description directed to general and preferred aspects of the present invention.
1. An effect pigment composition comprising one or more transparent platy substrates comprising a near refractive index coating that is matched to the substrate.
2. The composition of paragraph 1, wherein the substrates are selected from the group consisting of mica, glass flakes, SiO₂, Al₂O₃, BiOCI, kaolin, ZnO, BN, perlite and mixtures thereof, preferably from the group consisting of mica, glass flakes, perlite, and mixtures thereof, more preferably the substrate comprises, more preferably is mica.
3. The composition of paragraph 2, wherein the transparent platy substrate is a mica selected from the group consisting of muscovite (natural mica) and fluorophlogopite (synthetic mica), preferably the substrate comprises, more preferably is fluorophlogopite.
4. The composition of any preceding paragraph, wherein the refractive index of the transparent platy substrates is in the range of from 1.0 to 2.1, preferably from 1.2 to 2.0, more preferably in the range of from 1.3 to 1.9, more preferably in the range of from 1.4 to 1.8.
5. The composition of any preceding paragraph, wherein the refractive index of the near refractive index coating is in the range of from 1.0 to 2.1, preferably from 1.2 to 2.0, more preferably in the range of from 1.3 to 1.9, more preferably in the range of from 1.4 to 1.8.
6. The composition of any preceding paragraph, wherein the near refractive index coating has a refractive index within 0.3 of the substrate, preferably within the range of 0.0 to 0.29, more preferably within the range of 0.0 to 0.20, more preferably in the range of 0.0 to 0.15.
7. The composition of any preceding paragraph, wherein the near refractive index coating has a thickness in the range of from 30 to 170 nm, preferably in the range of from 40 to 160 nm, more preferably in the range of from 50 to 150 nm, determined according to high resolution scanning electron microscopy.
8. The composition of any preceding paragraph, wherein from 90 to 100 weight-%, preferably from 95 to 100 weight-%, more preferably from 98 to 100 weight-%, more preferably from 99 to 100 weight-% of the near refractive index coating consist of SiO₂, Al₂O₃, MgO, ZnO and a mixture thereof.
9. The composition of any preceding paragraph, wherein the near refractive index coating comprises a material, wherein the material is selected from the group consisting of SiO₂, Al₂O₃, MgO, ZnO and mixtures thereof, preferably from the group consisting of SiO₂, Al₂O₃, and mixtures thereof, more preferably the material for the near refractive index coating comprises, more preferably is SiO₂.
10. The composition of any preceding paragraph, wherein the near refractive index coating consist of two metal oxides A and B, which are mixed to create the near refractive index coating, wherein the refractive index of the near refractive index coating is determined using the following formula

$$n = {X}_{A} \cdot {n}_{A} + {X}_{B} \cdot {n}_{B} ,$$

wherein n is the resulting refractive index of the near refractive index coating; X_{A} is the mole fraction of the metal oxide A; n_{A} is the refractive index of the metal oxide A; X_{B} is the mole fraction of the metal oxide B; and n_{B} is the refractive index of the metal oxide B.
11. The composition of any preceding paragraph, wherein the substrates have a Dv50 in the range of from 5 to 100 microns, preferably the substrates have a Dv50 less than 30 microns, more preferably the substrates have a Dv50 in the range of from 5 to 30 microns, more preferably in the range of from 5 to 25 microns, determined according to reference example 1.
12. The composition of any preceding paragraph, further comprising a combination of subsequent optical layers.
13. The composition of paragraph 12, wherein the subsequent optical layers are selected from the group consisting of TiO₂, Fe₂O₃, TiO₂/Fe₂O₃, TiO₂/SiO₂/TiO₂, TiO₂/SiO₂/Fe₂O₃, Fe₂O₃/SiO₂/TiO₂, and Fe₂O₃/SiO₂/Fe₂O₃, preferably the subsequent optical layers are selected from the group consisting of TiO₂ and Fe₂O₃, more preferably the subsequent optical layer comprises, more preferably is a TiO₂ layer.
14. The composition of paragraph 12 or 13, wherein each subsequent optical layer has a thickness in the range of from 20 to 300 nm, preferably in the range of from 20 to 180 nm, more preferably in the range of from 20 to 130 nm, determined according to high resolution scanning electron microscopy.
15. The composition of any preceding paragraph, having a delta sparkle intensity Δ S_i in the range of from 0.5 to 5.0, preferably in the range of from 1.0 to 4.0, more preferably in the range of from 2.0 to 3.0, determined according to reference example 2.
16. The composition of any preceding paragraph, wherein the near refractive index coating further comprises SnO₂.
17. The composition of any preceding paragraph, wherein the near refractive index coating is applied by a method selected from the group consisting of aqueous precipitation, sol-gel and chemical vapour deposition.
18. The composition of any preceding paragraph, wherein prior to applying additional optical layers, the applied near refractive index coating is calcined.
19. A printing ink, paint or coating composition comprising the composition of any one or more of paragraphs 1-18.
20. The printing ink, paint or coating composition of paragraph 19 being an automotive coating.
21. A process for a preparation of the composition according any one of paragraphs 1-18, wherein the near refractive index coating is applied on the transparent platy substrates by a method selected from the group consisting of aqueous precipitation, sol-gel and chemical vapour deposition.
22. The process of paragraph 21, wherein the near refractive index coating is calcined prior to applying the combination of subsequent optical layers.
23. A process for increasing the sparkle of effect pigments based on transparent platy substrates, comprising applying a near refractive index coating that is matched to the substrate.
24. The process of paragraph 23, wherein the substrates are selected from the group consisting of mica, glass flakes, SiO₂, Al₂O₃, BiOCI, kaolin, ZnO, BN, perlite and mixtures thereof, preferably from the group consisting of mica, glass flakes, perlite, and mixtures thereof, more preferably the substrate comprises, more preferably is mica.
25. The process of paragraph 24, wherein the transparent platy substrate is a mica selected from the group consisting of muscovite (natural mica) and fluorophlogopite (synthetic mica), preferably the substrate comprises, more preferably is fluorophlogopite.
26. The process of paragraph 23, wherein the refractive index of the transparent platy substrates is in the range of from 1.0 to 2.1, preferably from 1.2 to 2.0, more preferably in the range of from 1.3 to 1.9, more preferably in the range of from 1.4 to 1.8.
27. The process of paragraph 23, wherein the refractive index of the near refractive index coating is in the range of from 1.0 to 2.1, preferably from 1.2 to 2.0, more preferably in the range of from 1.3 to 1.9, more preferably in the range of from 1.4 to 1.8.
28. The process of paragraph 23, wherein the near refractive index coating has a refractive index within 0.3 of the substrate, preferably within the range of 0.0 to 0.29, more preferably within the range of 0.0 to 0.20, more preferably in the range of 0.0 to 0.15.
29. The process of paragraph 23, wherein the near refractive index coating has a thickness in the range of from 30 to 170 nm, preferably in the range of from 40 to 160 nm, more preferably in the range of from 50 to 150 nm, determined according to high resolution scanning electron microscopy.
30. The process of paragraph 23, wherein from 90 to 100 weight-%, preferably from 95 to 100 weight-%, more preferably from 98 to 100 weight-%, more preferably from 99 to 100 weight-% of the near refractive index coating consist of SiO₂, Al₂O₃, MgO, ZnO and a mixture thereof.
31. The process of paragraph 23, wherein the near refractive index coating comprises a material, wherein the material is selected from the group consisting of SiO₂, Al₂O₃, MgO and mixtures thereof, preferably from the group consisting of SiO₂, Al₂O₃, and mixtures thereof, more preferably the material for the near refractive index coating comprises, more preferably is SiO₂.
32. The process of paragraph 23, wherein the near refractive index coating consist of two metal oxides A and B, which are mixed to create the near refractive index coating, wherein the refractive index of the near refractive index coating is determined using the following formula

$$n = {X}_{A} \cdot {n}_{A} + {X}_{B} \cdot {n}_{B} ,$$

wherein n is the resulting refractive index of the near refractive index coating; X_{A} is the mole fraction of the metal oxide A; n_{A} is the refractive index of the metal oxide A; X_{B} is the mole fraction of the metal oxide B; and n_{B} is the refractive index of the metal oxide B.
33. The process of paragraph 23, wherein the substrates have a Dv50 in the range of from 5 to 100 microns, preferably the substrates have a Dv50 less than 30 microns, more preferably the substrates have a Dv50 in the range of from 5 to 30 microns, more preferably in the range of from 5 to 25 microns, determined according to reference example 1.
34. The process of paragraph 23, further comprising a combination of subsequent optical layers.
35. The process of paragraph 23, wherein the subsequent optical layers are selected from the group consisting of TiO₂, Fe₂O₃, TiO₂/Fe₂O₃, TiO₂/SiO₂/TiO₂, TiO₂/SiO₂/Fe₂O₃, Fe₂O₃/SiO₂/TiO₂, and Fe₂O₃/SiO₂/Fe₂O₃, preferably the subsequent optical layers are selected from the group consisting of TiO₂ and Fe₂O₃, more preferably the subsequent optical layer comprises, more preferably is a TiO₂ layer.
36. The process of paragraph 23, wherein each subsequent optical layer has a thickness in the range of from 20 to 300 nm, preferably in the range of from 20 to 180 nm, more preferably in the range of from 20 to 130 nm, determined according to high resolution scanning electron microscopy.
37. The process of paragraph 23, having a delta sparkle intensity Δ S_i in the range of from 0.5 to 5.0, preferably in the range of from 1.0 to 4.0, more preferably in the range of from 2.0 to 3.0, determined according to reference example 2.
38. The process of paragraph 23, wherein the near refractive index coating further comprises SnO₂.
39. The process of paragraph 23, wherein the near refractive index coating is applied by a method selected from the group consisting of aqueous precipitation, sol-gel and chemical vapour deposition.
40. The process of paragraph 23, wherein prior to applying additional optical layers, the applied near refractive index coating is calcined.

Further, the present invention relates to an effect pigment comprising:
(i) a transparent platy substrate having a refractive index in the range of from 1.0 to 2.1;
(ii) a first coating on the transparent platy substrate according to (i), said first coating comprising at least one first metal oxide selected from the group consisting of SiO₂, Al₂O₃, MgO, ZnO and a mixture thereof;
wherein the refractive index of the first coating according to (ii) is at most 0.3 of the refractive index of the transparent platy substrate according to (i).

It is preferred that the refractive index of the transparent platy substrate according to (i) is in the range of from 1.2 to 2.0, preferably in the range of from 1.3 to 1.9, more preferably in the range of from 1.4 to 1.8.

It is preferred that the transparent platy substrate according to (i) is selected from the group consisting of mica, glass flakes, SiO₂, Al₂O₃, BiOCI, kaolin, ZnO, BN, perlite, and a mixture thereof, preferably from the group consisting of a mica, glass flakes, a perlite, and a mixture thereof, wherein more preferably, the transparent platy substrate according to (i) comprises, more preferably is a mica.

In case where the transparent platy substrate according to (i) is mica, the mica is muscovite, fluorophlogopite, or a mixture thereof, preferably fluorophlogopite.

Muscovite is a natural mica and fluorophlogopite is a synthetic mica.

It is preferred that the transparent platy substrate according to (i) has a Dv50 in the range of from 5 to 100 μm, more preferably in the range of from 5 to 50 μm, more preferably in the range of from 5 to 30 μm, more preferably in the range of from 5 to 25 μm, determined according to reference example 1.

It is preferred that the refractive index of the first coating according to (ii) is in the range of from 1 to 2.1, more preferably in the range of from 1.2 to 2.0, more preferably in the range of from 1.3 to 1.9, more preferably in the range of from 1.4 to 1.8.

It is preferred that the refractive index of the first coating according to (ii) is the range of 0 to 0.29 of the refractive index of the transparent platy substrate according to (i), more preferably in the range of 0.0 to 0.20, more preferably in the range of 0.0 to 0.15.

It is preferred that from 90 to 100 weight-%, preferably from 95 to 100 weight-%, more preferably from 98 to 100 weight-%, more preferably from 99 to 100 weight-% of the first coating according to (ii) consist of the at least one first metal oxide selected from the group consisting of SiO₂, Al₂O₃, MgO, ZnO and a mixture thereof.

It is preferred that the at least one first metal oxide is selected from the group consisting of SiO₂, Al₂O₃, MgO, and a mixture thereof, more preferably from the group consisting of SiO₂, Al₂O₃, and a mixture thereof, more preferably the first metal oxide comprises, more preferably is SiO₂.

It is preferred that the first coating according to (ii) has a thickness in the range of from to 170 nm, more preferably in the range of from 40 to 160 nm, more preferably in the range of from 50 to 150 nm, determined according to high resolution scanning electron microscopy.

The expression “thickness” of a coating refers to the physical thickness of the coating.

It is preferred that the first coating according to (ii) consists of k metal oxides A(i), i=1 . . . k, k>1, wherein the refractive index n of the first coating is defined as

$$n = {\sum }_{i = 1}^{k} {X}_{A} ( i ) {n}_{A} ( i )$$

wherein
X_{A}(i) is the mole fraction of the metal oxide A(i) comprised in the first coating;
n_{A}(i) is the refractive index of the metal oxide A(i) as individual compound.

It is preferred that the first coating according to (ii) further comprises SnO₂.

It is preferred that the effect pigment of any one of the particular and preferred embodiments of the present invention further comprises:
(iii) a second coating on the first coating according to (ii) having a refractive index in the range of from 2.2 to 4 and comprising at least one second metal oxide selected from the group consisting of TiO₂, Fe₂O₃, Fe₃O₄, and a mixture thereof, preferably from the group consisting of TiO₂, Fe₂O₃, and a mixture thereof, more preferably the second metal oxide comprises TiO₂.

In case where the effect pigment of any one of the particular and preferred embodiments of the present invention comprises a second coating according to (iii), the refractive index of the second coating according to (iii) is in the range of from 2.5 to 3.5.

It is preferred that from 90 to 100 weight-%, preferably from 95 to 100 weight-%, more preferably from 98 to 100 weight-%, more preferably from 99 to 100 weight-% of the second coating according to (iii) consist of the at least one second metal oxide selected from the group consisting of TiO₂, Fe₂O₃, Fe₃O₄, and a mixture thereof.

It is preferred that the second coating according to (iii) has a thickness in the range of from 20 to 300 nm, preferably in the range of from 20 to 180 nm, more preferably in the range of from 20 to 130 nm, determined according to high resolution scanning electron microscopy.

It is preferred that the second coating according to (iii) further comprises SnO₂.

It is preferred that the effect pigment of any one of the particular and preferred embodiments of the present invention comprises two coatings, wherein the first coating according to (ii) comprises SiO₂ and the second coating according to (iii) comprises TiO₂; or the first coating according to (ii) comprises SiO₂ and the second coating according to (iii) comprises Fe₂O₃.

It is preferred that the effect pigment of any one of the particular and preferred embodiments of the present invention further comprises:
(iv) a third coating on the second coating according to (iii) having a refractive index in a range of from 1 to 4 and comprising at least one third metal oxide selected from the group consisting of SiO₂, TiO₂, Fe₂O₃, Fe₃O₄, and a mixture thereof, preferably from the group consisting of SiO₂, TiO₂, Fe₂O₃, and a mixture thereof.

In case where the effect pigment of any one of the particular and preferred embodiments of the present invention comprises a third coating according to (iv), the refractive index of the third coating according to (iv) is in the range of from 2.5 to 3.5.

It is preferred that from 90 to 100 weight-%, preferably from 95 to 100 weight-%, more preferably from 98 to 100 weight-%, more preferably from 99 to 100 weight-% of the third coating according to (iv) consist of the at least one second metal oxide selected from the group consisting of SiO₂, TiO₂, Fe₂O₃, Fe₃O₄, and a mixture thereof.

It is preferred that the third coating according to (iv) has a thickness in the range of from to 300 nm, preferably in the range of from 20 to 180 nm, more preferably in the range of from 20 to 130 nm, determined according to high resolution scanning electron microscopy.

It is preferred that the third coating according to (iv) further comprises SnO₂.

It is preferred that the effect pigment of any one of the particular and preferred embodiments of the present invention comprises three coatings, wherein the first coating according to (ii) comprises SiO₂, the second coating according to (iii) comprises TiO₂ and the third coating according to (iv) comprises Fe₂O₃.

It is preferred that the effect pigment of any one of the particular and preferred embodiments of the present invention further comprises:
(v) a fourth coating on the third coating according to (iv) having a refractive index in a range of from 2.2 to 4 and comprising at least one fourth metal oxide selected from the group consisting of TiO₂, Fe₂O₃, Fe₃O₄, and a mixture thereof, preferably from the group consisting of TiO₂, Fe₂O₃, and a mixture thereof, more preferably the second metal oxide comprises, more preferably comprises, more preferably is TiO₂.

In case where the effect pigment of any one of the particular and preferred embodiments of the present invention comprises a fourth coating according to (v), the refractive index of the fourth coating according to (v) is in the range of from 2.5 to 3.5.

It is preferred that from 90 to 100 weight-%, preferably from 95 to 100 weight-%, more preferably from 98 to 100 weight-%, more preferably from 99 to 100 weight-% of the fourth coating according to (v) consist of the at least one second metal oxide selected from the group consisting of TiO₂, Fe₂O₃, Fe₃O₄, and a mixture thereof.

It is preferred that the fourth coating according to (v) has a thickness in the range of from to 300 nm, preferably in the range of from 20 to 180 nm, more preferably in the range of from 20 to 130 nm, determined according to high resolution scanning electron microscopy.

It is preferred that the fourth coating according to (v) further comprises SnO₂.

It is preferred that the effect pigment of any one of the particular and preferred embodiments of the present invention comprises four coatings, wherein the first coating according to (ii) comprises SiO₂, the second coating according to (iii) comprises TiO₂, the third coating according to (iv) comprises SiO₂ and the fourth coating according to (v) comprises TiO₂; or the first coating according to (ii) comprises SiO₂, the second coating according to (iii) comprises TiO₂; the third coating according to (iv) comprises SiO₂ and the fourth coating according to (v) comprises Fe₂O₃; or the first coating according to (ii) comprises SiO₂, the second coating according to (iii) comprises Fe₂O₃; the third coating according to (iv) comprises SiO₂ and the fourth coating according to (v) comprises TiO₂; or the first coating according to (ii) comprises SiO₂, the second coating according to (iii) comprises Fe₂O₃; the third coating according to (iv) comprises SiO₂ and the fourth coating according to (v) comprising Fe₂O₃.

It is preferred that the effect pigment of any one of the particular and preferred embodiments of the present invention has a delta sparkle intensity Δ S_i in the range of from 0.5 to 5.0, preferably in the range of from 1.0 to 4.0, more preferably in the range of from 2.0 to 3.0, determined according to reference example 2.

The present invention also relates to a process for preparing an effect pigment, preferably an effect pigment of any one of the particular and preferred embodiments of the present invention, the process comprising
(a) providing a transparent platy substrate having a refractive index in the range of from 1.0 to 2.1;
(b) coating a first composition comprising at least one first metal oxide precursor selected from the group consisting of Si, Al, Mg, Zn, and a mixture thereof onto the transparent platy substrate, obtaining a first uncalcined coating;
(c) calcining the transparent platy substrate and the first uncalcined coating at a temperature in the range of 650 to 950° C. in air at normal pressure for a period of from 5 to 60 min;
(d) obtaining the effect pigment comprising a first coating comprising at least one first metal oxide selected from the group consisting of SiO₂, Al₂O₃, MgO, ZnO, and a mixture thereof on the transparent platy substrate, said first coating having a refractive index of at most 0.30 of the transparent platy substrate;
wherein said coating according to (b) is carried out by one or more of aqueous precipitation, sol-gel coating and chemical vapour deposition.

It is preferred that prior to (c), the process further comprises
(b.i) coating a second composition comprising at least one second metal oxide precursor selected from the group consisting of Ti, Fe, and a mixture thereof onto the first coating, obtaining a second uncalcined coating.

It is preferred that prior to (b.i), the transparent platy substrate and the first uncalcined coating obtained according to (b) is subjected to calcination at a temperature in the range of 650 to 950° C. in air at normal pressure for a period of from 5 to 60 min.

It is preferred that the process of any one of the particular and preferred embodiments of the present invention, further comprises
(b.ii) coating at least one further composition onto the second coating obtained according to (b.1), wherein, if at least two further compositions are coated, they are preferably coated one after the other, thereby obtaining at least a third coating on the second coating and a fourth coating on the third coating, wherein more preferably, prior to coating a further composition onto a given coating, said coating is subjected to calcination.

The present invention also relates to an effect pigment, obtainable or obtained by a process of any one of the particular and preferred embodiments of the present invention.

The present invention also relates to a use of an effect pigment of any one of the particular and preferred embodiments of the present invention as a component of and/or for preparing one or more of a printing ink, a paint and a coating composition.

It is preferred that coating composition is an automotive coating composition.

The present invention also relates to a method for preparing one or more of a printing ink, a paint and a coating composition, comprising employing an effect pigment of any one of the particular and preferred embodiments of the present invention as a component.

It is preferred that the coating composition is an automotive coating composition.

The present invention also relates to a printing ink, a paint and/or a coating composition, comprising or consisting of an effect pigment of any one of the particular and preferred embodiments of the present invention.

The present invention also relates to a use of an effect pigment of any one of the particular and preferred embodiments of the present invention as a component in a printing ink, a paint and a coating composition for increasing the sparkle effect.

The present invention also relates to a method for increasing the sparkle effect of one or more of a printing ink, a paint and a coating composition, comprising employing an effect pigment of any one of the particular and preferred embodiments of the present invention as a component.

The present invention is further illustrated by the following set of embodiments and combinations of embodiments resulting from the dependencies and back-references as indicated. In particular, it is noted that in each instance where a range of embodiments is mentioned, for example in the context of a term such as “The effect pigment of any one of embodiments 1 to 4”, every embodiment in this range is meant to be explicitly disclosed for the skilled person, i.e. the wording of this term is to be understood by the skilled person as being synonymous to “The effect pigment of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. An effect pigment comprising:
   (i) a transparent platy substrate having a refractive index in the range of from 1.0 to 2.1;
   (ii) a first coating on the transparent platy substrate according to (i), said first coating comprising at least one first metal oxide selected from the group consisting of SiO₂, Al₂O₃, MgO, ZnO and a mixture thereof;
   wherein the refractive index of the first coating according to (ii) is at most 0.3 of the refractive index of the transparent platy substrate according to (i).
2. The effect pigment of embodiment 1, wherein the refractive index of the transparent platy substrate according to (i) is in the range of from 1.2 to 2.0, preferably in the range of from 1.3 to 1.9, more preferably in the range of from 1.4 to 1.8.
3. The effect pigment of embodiment 1 or 2, wherein the transparent platy substrate according to (i) is selected from the group consisting of mica, glass flakes, SiO₂, Al₂O₃, BiOCI, kaolin, ZnO, BN, perlite, and a mixture thereof, from the group consisting of a mica, glass flakes, a perlite, and a mixture thereof, wherein more preferably, the transparent platy substrate according to (i) comprises, more preferably is a mica.
4. The effect pigment of embodiment 3, wherein the mica is muscovite, fluorophlogopite, or a mixture thereof, preferably fluorophlogopite.
5. The effect pigment of any one of embodiments 1 to 4, wherein the transparent platy substrate according to (i) has a Dv50 in the range of from 5 to 100 μm, preferably in the range of from 5 to 50 μm, more preferably in the range of from 5 to 30 μm, more preferably in the range of from 5 to 25 μm, determined according to reference example 1.
6. The effect pigment of any one of embodiments 1 to 5, wherein the refractive index of the first coating according to (ii) is in the range of from 1 to 2.1, preferably in the range of from 1.2 to 2.0, more preferably in the range of from 1.3 to 1.9, more preferably in the range of from 1.4 to 1.8.
7. The effect pigment of any one of embodiments 1 to 6, wherein the refractive index of the first coating according to (ii) is the range of 0 to 0.29 of the refractive index of the transparent platy substrate according to (i), preferably in the range of 0.0 to 0.20, more preferably in the range of 0.0 to 0.15.
8. The effect pigment of any one of embodiments 1 to 7, wherein from 90 to 100 weight-%, preferably from 95 to 100 weight-%, more preferably from 98 to 100 weight-%, more preferably from 99 to 100 weight-% of the first coating according to (ii) consist of the at least one first metal oxide selected from the group consisting of SiO₂, Al₂O₃, MgO, ZnO and a mixture thereof.
9. The effect pigment of any one of embodiments 1 to 8, wherein the at least one first metal oxide is selected from the group consisting of SiO₂, Al₂O₃, MgO, and a mixture thereof, preferably from the group consisting of SiO₂, Al₂O₃, and a mixture thereof, more preferably the first metal oxide comprises, more preferably is SiO₂.
10. The effect pigment of any one of embodiments 1 to 9, wherein the first coating according to (ii) has a thickness in the range of from 30 to 170 nm, preferably in the range of from 40 to 160 nm, more preferably in the range of from 50 to 150 nm, determined according to high resolution scanning electron microscopy.
11. The effect pigment of any one of embodiment 1 to 10, wherein the first coating according to (ii) consists of k metal oxides A (i), i=1 . . . k, k>1, wherein the refractive index n of the first coating is defined as

$$n = {\sum }_{i = 1}^{k} {X}_{A} ( i ) {n}_{A} ( i )$$

wherein
X_{A}(i) is the mole fraction of the metal oxide A (i) comprised in the first coating;
n_{A}(i) is the refractive index of the metal oxide A (i) as individual compound.
12. The effect pigment of any one of embodiments 1 to 11, wherein the first coating according to (ii) further comprises SnO₂.
13. The effect pigment of any one of embodiments 1 to 12, further comprising:
   (iii) a second coating on the first coating according to (ii) having a refractive index in the range of from 2.2 to 4 and comprising at least one second metal oxide selected from the group consisting of TiO₂, Fe₂O₃, Fe₃O₄, and a mixture thereof, preferably from the group consisting of TiO₂, Fe₂O₃, and a mixture thereof, more preferably the second metal oxide comprises TiO₂.
14. The effect pigment of embodiment 13, wherein the refractive index of the second coating according to (iii) is in the range of from 2.5 to 3.5.
15. The effect pigment of embodiment 13 or 14, wherein from 90 to 100 weight-%, preferably from 95 to 100 weight-%, more preferably from 98 to 100 weight-%, more preferably from 99 to 100 weight-% of the second coating according to (iii) consist of the at least one second metal oxide selected from the group consisting of TiO₂, Fe₂O₃, Fe₃O₄, and a mixture thereof.
16. The effect pigment of any one of embodiments 13 to 15, wherein the second coating according to (iii) has a thickness in the range of from 20 to 300 nm, preferably in the range of from 20 to 180 nm, more preferably in the range of from 20 to 130 nm, determined according to high resolution scanning electron microscopy.
17. The effect pigment of any one of embodiments 13 to 16, wherein the second coating according to (iii) further comprises SnO₂.
18. The effect pigment of any one of embodiments 13 to 17, wherein the effect pigment comprises two coating s, wherein
   the first coating according to (ii) comprises SiO₂ and the second coating according to (iii) comprises TiO₂; or
   the first coating according to (ii) comprises SiO₂ and the second coating according to (iii) comprises Fe₂O₃.
19. The effect pigment of any one of embodiments 13 to 18, further comprising:
   (iv) a third coating on the second coating according to (iii) having a refractive index in a range of from 1 to 4 and comprising at least one third metal oxide selected from the group consisting of SiO₂, TiO₂, Fe₂O₃, Fe₃O₄, and a mixture thereof, preferably from the group consisting of SiO₂, TiO₂, Fe₂O₃, and a mixture thereof.
20. The effect pigment of embodiment 18, wherein the refractive index of the third coating according to (iv) is in the range of from 2.5 to 3.5.
21. The effect pigment of embodiment 18 or 19, wherein from 90 to 100 weight-%, preferably from 95 to 100 weight-%, more preferably from 98 to 100 weight-%, more preferably from 99 to 100 weight-% of the third coating according to (iv) consist of the at least one second metal oxide selected from the group consisting of SiO₂, TiO₂, Fe₂O₃, Fe₃O₄, and a mixture thereof.
22. The effect pigment of any one of embodiments 18 to 20, wherein the third coating according to (iv) has a thickness in the range of from 20 to 300 nm, preferably in the range of from 20 to 180 nm, more preferably in the range of from 20 to 130 nm, determined according to high resolution scanning electron microscopy.
23. The effect pigment of any one of embodiments 18 to 22, wherein the third coating according to (iv) further comprises SnO₂.
24. The effect pigment of any one of embodiments 18 to 23, wherein the effect pigment comprises three coatings, wherein the first coating according to (ii) comprises SiO₂, the second coating according to (iii) comprises TiO₂ and the third coating according to (iv) comprises Fe₂O₃.
25. The effect pigment of any one of embodiments 18 to 24, further comprising:
   (v) a fourth coating on the third coating according to (iv) having a refractive index in a range of from 2.2 to 4 and comprising at least one fourth metal oxide selected from the group consisting of TiO₂, Fe₂O₃, Fe₃O₄, and a mixture thereof, preferably from the group consisting of TiO₂, Fe₂O₃, and a mixture thereof, more preferably the second metal oxide comprises, more preferably comprises, more preferably is TiO₂.
26. The effect pigment of embodiment 24 wherein the refractive index of the fourth coating according to (v) is in the range of from 2.5 to 3.5.
27. The effect pigment of embodiment 25 or 26, wherein from 90 to 100 weight-%, preferably from 95 to 100 weight-%, more preferably from 98 to 100 weight-%, more preferably from 99 to 100 weight-% of the fourth coating according to (v) consist of the at least one second metal oxide selected from the group consisting of TiO₂, Fe₂O₃, Fe₃O₄, and a mixture thereof.
28. The effect pigment of any one of embodiments 25 to 27, wherein the fourth coating according to (v) has a thickness in the range of from 20 to 300 nm, preferably in the range of from 20 to 180 nm, more preferably in the range of from 20 to 130 nm, determined according to high resolution scanning electron microscopy.
29. The effect pigment of any one of embodiments 25 to 28, wherein the fourth coating according to (v) further comprises SnO₂.
30. The effect pigment of any one of embodiments 25 to 29, wherein the effect pigment comprises four coatings, wherein the first coating according to (ii) comprises SiO₂, the second coating according to (iii) comprises TiO₂, the third coating according to (iv) comprises SiO₂ and the fourth coating according to (v) comprises TiO₂; or the first coating according to (ii) comprises SiO₂, the second coating according to (iii) comprises TiO₂; the third coating according to (iv) comprises SiO₂ and the fourth coating according to (v) comprises Fe₂O₃; or the first coating according to (ii) comprises SiO₂, the second coating according to (iii) comprises Fe₂O₃; the third coating according to (iv) comprises SiO₂ and the fourth coating according to (v) comprises TiO₂; or the first coating according to (ii) comprises SiO₂, the second coating according to (iii) comprises Fe₂O₃; the third coating according to (iv) comprises SiO₂ and the fourth coating according to (v) comprising Fe₂O₃.
31. The effect pigment of any one of embodiments 1 to 30, having a delta sparkle intensity Δ S_i in the range of from 0.5 to 5.0, preferably in the range of from 1.0 to 4.0, more preferably in the range of from 2.0 to 3.0, determined according to reference example 2.
32. A process for preparing an effect pigment, preferably an effect pigment according to any one of embodiments 1 to 31, the process comprising
   (a) providing a transparent platy substrate having a refractive index in the range of from 1.0 to 2.1;
   (b) coating a first composition comprising at least one first metal oxide precursor selected from the group consisting of Si, Al, Mg, Zn, and a mixture thereof onto the transparent platy substrate, obtaining a first uncalcined coating;
   (c) calcining the transparent platy substrate and the first uncalcined coating at a temperature in the range of 650 to 950° C. in air at normal pressure for a period of from 5 to 60 min;
   (d) obtaining the effect pigment comprising a first coating comprising at least one first metal oxide selected from the group consisting of SiO₂, Al₂O₃, MgO, ZnO, and a mixture thereof on the transparent platy substrate, said first coating having a refractive index of at most 0.30 of the transparent platy substrate;
   wherein said coating according to (b) is carried out by one or more of aqueous precipitation, sol-gel coating and chemical vapour deposition.
33. The process of embodiment 32, wherein prior to (c), the process further comprises
   (b.i) coating a second composition comprising at least one second metal oxide precursor selected from the group consisting of Ti, Fe, and a mixture thereof onto the first coating, obtaining a second uncalcined coating.
34. The process of embodiment 32 or 33, wherein prior to (b.i), the transparent platy substrate and the first uncalcined coating obtained according to (b) is subjected to calcination at a temperature in the range of 650 to 950° C. in air at normal pressure for a period of from 5 to 60 min.
35. The process of any one of embodiments 32 to 34, further comprising
   (b.ii) coating at least one further composition onto the second coating obtained according to (b.1), wherein, if at least two further compositions are coated, they are preferably coated one after the other, thereby obtaining at least a third coating on the second coating and a fourth coating on the third coating, wherein more preferably, prior to coating a further composition onto a given coating, said coating is subjected to calcination.
37. An effect pigment, obtainable or obtained by a process according to any one of embodiments 32 to 36.
38. Use of an effect pigment according to any one of embodiments 1 to 31 and 37 as a component of and/or for preparing one or more of a printing ink, a paint and a coating composition.
39. The use of embodiment 38, wherein the coating composition is an automotive coating composition.
40. A method for preparing one or more of a printing ink, a paint and a coating composition, comprising employing an effect pigment according to any one of embodiments 1 to 31 and 37 as a component.
41. The method of embodiment 40, wherein the coating composition is an automotive coating composition.
42. A printing ink, a paint and/or a coating composition, comprising or consisting of an effect pigment according to any one of embodiments 1 to 31 and 37.
43. Use of an effect pigment according to any one of embodiments 1 to 31 and 37 as a component in a printing ink, a paint and a coating composition for increasing the sparkle effect.
44. A method for increasing the sparkle effect of one or more of a printing ink, a paint and a coating composition, comprising employing an effect pigment according to any one of embodiments 1 to 31 and 37 as a component.

The present invention has been described in detail, including the preferred embodiments thereof. However, it will be appreciated that those skilled in the art, upon consideration of the present disclosure, may make modifications and/or improvements on this invention that fall within the scope and spirit of the invention.

The invention is further described by the following non-limiting examples which further illustrate the invention, and are not intended, nor should they be interpreted to, limit the scope of the invention.

### REFERENCE EXAMPLES

### Reference Example 1 (Determination of Dv50)

The Dv50 value was determined using the Malvern Mastersizer apparatus.

### Reference Example 2 (Determination of the Sparkle Values and CIELab Values)

The sparkle grade S_G represents the total sparkle of a pigment, which is a mathematical combination of S_i and S_a values. S_i represents the sparkle intensity and relates to the intensity of the detected light rays. S_a represents the sparkle area and relates to the number of light reflections per surface unit.

The sparkle grade S_G of the pigment according to the present invention, as well as S_i and S_a and h, C*, L*, Δ H*, Δ C*, Δ L* and Δ E* values were determined using a BYK-mac device (from BYK Gardner) at the 15° and −15° angles. In order to determine the sparkle and CIELab data of the pigments, the dried and cured coating films obtained of the 90:10 black reduction are applied and measured as follows: the pigment was incorporated (as a 50:50 slurry of the pigment in a solvent which is part of the varnish) by stirring with a level of total pigmentation of 5 wt.-% (based on the total weight of the wet varnish) into a conventional solvent-borne, medium solids cellulose acetobutyrate (CAB)/polyester varnish (pigment/binder 20/100), until the pigment is finally dispersed. The completed varnish was applied by pneumatic spray application onto aluminum panels with a wet film thickness of about 150 to 160 μm and subsequently dried at room temperature. After drying, the basecoat was overcoated by a 1K clearcoat (a clearcoat comprising blocked isocyanates, acrylic polymers with OH functions, melamine cross linkers, and other additives like UV absorber, antioxidants and levelling agents), dried and cured at 135° C. After curing, the basecoat was about 20 μm thick and the clearcoat was about 40 μm thick.

### Reference Example 3 (Determination of the Thickness)

The thickness was determined using cross cuts of the pigments in a resin. The cross cuts were obtained by using wet diamond cut and mechanic polishing. The thickness of the obtained cross cuts was determined using high resolution scanning electron microscopy and EDS observation. The apparatuses SEM (JSM7800F, JOEL) and EDS (X-MAX80 mm2, Oxford) were used.

### EXAMPLES AND COMPARATIVE EXAMPLES

### Example 1

A 10% aqueous slurry containing 200 g of synthetic mica flakes (fluorophlogopite, average particle size (Dv50)~20 microns) was stirred at room temperature. The pH of the slurry was adjusted to 1.4 with 28% HCl, then 22.4 g of 20% SnCl₄·5H₂O (an aqueous solution containing 20 wt. % SnCl₄·5H₂O and 80 wt. % water) were added at a rate of 1.0 g/min while maintaining the pH at 1.40 by addition of 10% NaOH. The slurry was allowed to stir for 30 min before heating to 74° C. At temperature, the pH of the slurry was slowly raised to 7.8 with 35% NaOH. Then, 900 g of 20% Na₂SiO₃·5H₂O (an aqueous solution containing 20 wt. % Na₂SiO₃·5H₂O and 80 wt. % water) was added at 2.0 g/min while maintaining the pH at 7.80 by addition of 28% HCl. After the addition was complete, the pH of the slurry was slowly adjusted to 1.4 with 28% HCl, then, after an hour stir, 22.4 g of 20% SnCl₄·5H₂O (an aqueous solution containing 20 wt. % SnCl₄·5H₂O and 80 wt. % water) were added at a rate of 1.0 g/min while maintaining the pH at 1.4 by addition of 10% NaOH. The slurry was allowed to stir for 30 min before adding 475 g of 40% TiCl₄ (an aqueous solution containing 40 wt. % TiCl₄ and 60 wt. % water) at a rate of 1.25 g/min while maintaining the pH at 1.4 by addition of 35% NaOH. At the desired pearl shade, 50 mL of the slurry was filtered, the presscake washed with water, dried at 120° C. for 30 minutes, and calcined at 850° C. for 20 min. The sample was drawn down for color measurement. The first coating comprising SiO₂ had a thickness of 50 nm and the second coating comprising TiO₂ had a thickness of 30 to 50 nm. The obtained pigment had a pearl hue with improved sparkle.

### Example 2

Example 2 was run with the same procedure as Example 1 except that 1100 g of the 20% Na₂SiO₄·5H₂O (an aqueous solution containing 20 wt. % SnCl₄·5H₂O and 80 wt. % water) and 455 g of 40% TiCl₄ (an aqueous solution containing 40 wt. % TiCl₄ and 60 wt. % water) was added. The first coating comprising SiO₂ had a thickness of 50 nm and the second coating comprising TiO₂ had a thickness of 30 to 50 nm. The obtained pigment had a pearl hue with improved sparkle.

### Example 3

Example 3 was run with the same procedure as Example 1 except that 1300 g of the 20% Na₂SiO₄·5H₂O (an aqueous solution containing 20 wt. % SnCl₄·5H₂O and 80 wt. % water) and 480 g of 40% TiCl₄ (an aqueous solution containing 40 wt. % TiCl₄ and 60 wt. % water) was added. The first coating comprising SiO₂ had a thickness of 50 to 100 nm and the second coating comprising TiO₂ had a thickness of 30 to 50 nm. The obtained pigment had a pearl hue with improved sparkle.

### Example 4

Example 4 was run with the same procedure as Example 1 except that 2000 g of the 20% Na₂SiO₄·5H₂O (an aqueous solution containing 20 wt. % Na₂SiO₃·5H₂O and 80 wt. % water) and 425 g of 40% TiCl₄ (an aqueous solution containing 40 wt. % TiCl₄ and 60 wt. % water) was added. The first coating comprising SiO₂ has a thickness of 100 nm and the second coating comprising TiO₂ has a thickness of 30 to 50 nm. The obtained pigment had a golden hue with improved sparkle.

### Comparative Example 1

Comparative Example 1 was run with the same procedure as Example 1 except that no 20% Na₂SiO₄·5H₂O was added nor was the second 20% SnCl₄·5H₂O added. Only the first 11.2 g of 20% SnCl₄·5H₂O and 555 g of 40% TiCl₄ (an aqueous solution containing 40 wt. % TiCl₄ and 60 wt. % water) were used as in a conventional pearl shade effect pigment. A 100 mL of the slurry was filtered, the presscake washed with water, and calcined at 850° C. for 20 min. The sample was drawn down for color measurement. The obtained pigment hade a pearl shade with poor sparkle.

### Example 5

Example 5 was run with the same procedure as Example 4 except that the 20% Na₂SiO₄·5H₂O (an aqueous solution containing 20 wt. % Na₂SiO₄·5H₂O and 80 wt. % water) was added at 3.0 g/min and 890 g of 40% TiCl₄ (an aqueous solution containing 40 wt. % TiCl₄ and 60 wt. % water) was added until the desired gold shade was achieved. The calcination temperature was 825° C. The first coating comprising SiO₂ had a thickness of 100 nm. The obtained pigment had a blue hue with improved sparkle.

### Comparative Example 2

Comparative Example 2 was run with the same procedure as Comparative Example 1 except that 970 g of 40% TiCl₄ (an aqueous solution containing 40 wt. % TiCl₄ and 60 wt. % water) were used as in a conventional gold shade effect pigment. The calcination temperature was 825° C. The obtained pigment hade a gold hue with poor sparkle.

### Example 6

Example 6 was run with the same procedure as Example 4 except that the 20% Na₂SiO₄·5H₂O (an aqueous solution containing 20 wt. % Na₂SiO₄·5H₂O and 80 wt. % water) was added at 3.0 g/min and 1465 g of 40% TiCl₄ (an aqueous solution containing 40 wt. % TiCl₄ and 60 wt. % water) was added until the desired blue shade was achieved. The calcination temperature was 825° C. The first coating comprising SiO₂ has a thickness of 100 nm. The obtained blue interference pigment was showing a stronger sparkle than Comparative Example 3.

### Comparative Example 3

Comparative Example 3 was run with the same procedure as Comparative Example 1 except that 1480 g of 40% TiCl₄ (an aqueous solution containing 40 wt. % TiCl₄ and 60 wt. % water) were used as in a conventional Blue shade effect pigment. The calcination temperature was 825° C. The obtained pigment hade a blue hue with poor sparkle.

In order to determine the sparkle and CIELab values of the pigments prepared in the above examples, the dried and cured coating films obtained of the 90:10 black reduction are applied and measured as follows: pigment was incorporated (as a 50:50 slurry of pigment in a solvent which is part of the varnish) by stirring with a level of total pigmentation of 5 wt % (based on the total weight of the wet varnish) into a conventional solvent-borne, medium solids cellulose acetobutyrate (CAB)/polyester varnish (pigment/binder 20/100), until the pigment is finally dispersed. The completed varnish was applied by pneumatic spray application onto aluminum panels with a wet film thickness of about 150 to 160 μm and subsequently dried at room temperature. After drying, the basecoat was overcoated by a 1K clearcoat (a clearcoat comprising blocked isocyanates, acrylic polymers with OH functions, melamine cross linkers, and other additives like UV absorber, antioxidants and levelling agents), dried and cured at 135° C. After curing, the basecoat was about 20 μm thick and the clearcoat was about 40 μm thick. The sparkle effect of these panels was measured using a BYK-mac device (from BYK Gardner). The sparkle values (S_a, S_i and S_G) reported in Table 3 is at the 15° angle and clearly show the increased sparkle of the examples over the comparative examples.

TABLE 3
Measured sparkle values at 15°

| | Sparkle | Sparkle | Sparkle | | |
|---|---|---|---|---|---|
| | Area | Intensity | Grade | | |
| | S_a | S_i | (S_G) | Δ S_i | Δ S_a |
| Comparative | 35.42 | 16.47 | 7.65 | | |
| Example 1 | | | | | |
| Example 1 | 35.04 | 17.02 | 7.75 | 0.55 | −0.38 |
| Example 2 | 34.22 | 18.99 | 8.12 | 2.52 | −1.2 |
| Example 3 | 36.07 | 18.53 | 8.25 | 2.05 | 0.64 |
| Example 4 | 35.54 | 19.34 | 8.38 | 2.87 | 0.12 |
| Comparative | 33.5 | 16.1 | 7.3 | | |
| Example 2 | | | | | |
| Example 5 | 34 | 19 | 8.1 | 2.9 | 0.5 |
| Comparative | 33.9 | 10.8 | 5.9 | | |
| Example 3 | | | | | |
| Example 6 | 34.1 | 12.9 | 6.5 | 2.1 | 0.2 |

TABLE 4
Measured CIELab values

| Color Position | | | | | | | |
|---|---|---|---|---|---|---|---|
| [Spex(0.00) | | | | | | | |
| D65] −15° | h | C* | L* | Δ H* | Δ C* | Δ L* | Δ E* |
| Comparative | 230.9 | 3.13 | 85.21 | | | | |
| Example 1 | | | | | | | |
| Example 1 | 241.5 | 3.59 | 80.84 | 0.6 | 0.5 | −4.4 | 4.4 |
| Example 2 | 251 | 4.1 | 83.51 | 1.3 | 1 | −1.7 | 2.3 |
| Example 3 | 254.3 | 3.52 | 82.74 | 1.3 | 0.4 | −2.5 | 2.8 |
| Example 4 | 242.8 | 5.41 | 82.1 | 0.9 | 2.3 | −3.1 | 3.9 |
| Comparative | 82.17 | 51.71 | 68.44 | | | | |
| Example 2 | | | | | | | |
| Example 5 | 85.59 | 48.21 | 72.49 | 3 | −3.5 | 4 | 6.1 |
| Comparative | 260.35 | 41.4 | 44.22 | | | | |
| Example 3 | | | | | | | |
| Example 6 | 261.13 | 35.12 | 44.71 | 0.5 | −6.3 | 0.5 | 6.3 |
| Comparative | 221 | 2.3 | 77.24 | | | | |
| Example 1 | | | | | | | |
| Example 1 | 246.9 | 3.23 | 74.08 | 1.2 | 0.9 | −3.2 | 3.5 |
| Example 2 | 250.6 | 3.85 | 76.96 | 1.5 | 1.5 | −0.3 | 2.2 |
| Example 3 | 241.3 | 3.32 | 76.58 | 1 | 1 | −0.7 | 1.6 |
| Example 4 | 222.7 | 4.27 | 75.87 | 0.1 | 2 | −1.4 | 2.4 |
| Comparative | 79.16 | 46.92 | 59.85 | | | | |
| Example 2 | | | | | | | |
| Example 5 | 82.22 | 46.45 | 64.61 | 2.5 | −0.5 | 4.8 | 5.4 |
| Comparative | 247.47 | 35.51 | 42.04 | | | | |
| Example 3 | | | | | | | |
| Example 6 | 245.53 | 30.31 | 42.98 | −1.1 | −5.2 | 0.9 | 5.4 |

### CITED LITERATURE

U.S. Pat. No. 10,214,651B1
U.S. Pat. No. 7,699,927B1
CN108165053A
WO2008120846A1
U.S. Pat. No. 7,485,183B1
U.S. Pat. No. 8,883,879B1
U.S. Pat. No. 8,500,901B1
U.S. Pat. No. 10,597,544B1
US20130164356B1
U.S. Pat. No. 11,180,659B1
U.S. Pat. No. 10,647,861B1
EP2917285A1
U.S. Pat. No. 8,529,876B1
US20080279796B1
U.S. Pat. No. 8,268,069B1
US20200369891B1
IN-240942
US20170105915A1
US20210115260A1
CN211416537U
US20070298149B1
EP3596170A1
US20210087403A1
CN109181364A
US20200339820A1

1. An effect pigment composition comprising one or more transparent platy substrates comprising a near refractive index coating that is matched to the substrate;
wherein the substrates are selected from the group consisting of mica, glass flakes, SiO₂, AI₂O₃, BiOCI, kaolin, ZnO, BN, perlite and mixtures thereof;
wherein the refractive index of the transparent platy substrates is in the range of from 1.4 to 1.8;
wherein the refractive index of the near refractive index coating is in the range of from 1.4 to 1.8;
wherein the near refractive index coating has a refractive index within 0.0 t0 0.15 of the substrate;
wherein the near refractive index coating has a thickness in the range of from 50 to 150 nm; and
wherein the near refractive index coating consist of two metal oxides A and B, which are mixed to create the near refractive index coating, wherein the refractive index of the near refractive index coating is determined using the following formula n=X_{A}·n_{A}+X_{B}·n_{B}, wherein n is the resulting refractive index of the near refractive index coating; X_{A} is the mole fraction of the metal oxide A; n_{A} is the refractive index of the metal oxide A; X_{B} is the mole fraction of the metal oxide B; and n_{B} is the refractive index of the metal oxide B.

2. (canceled)

3. The composition of claim 2, wherein the transparent platy substrate is a mica selected from the group consisting of muscovite (natural mica) and fluorophlogopite (synthetic mica).

4-11. (canceled)

12. The composition of claim 3, further comprising a combination of subsequent optical layers;
wherein the subsequent optical layers are selected from the group consisting of TiO₂, Fe₂O₃, TiQ₂/Fe₂O₃, TiO₂/SiO₂/TiO₂, TiO₂/SiO₂/Fe₂O₃, Fe₂O₃/SiO₂/TiO₂, and Fe₂O₃/SiO₂/Fe₂O₃.

13-14. (canceled)

15. The composition of claim 3, wherein each subsequent optical layer has a thickness in the range of from 20 to 130 nm and having a delta sparkle intensity ΔS_i in the range of from 0.5 the 5.0, preferably in the range of from 1.0 to 4.0, more preferably in the range of from 2.0 to 3.0.

16-18. (canceled)

19. A printing ink, paint or coating composition comprising the composition of claim 1.

20-22. (canceled)

23. A process for increasing the sparkle of effect pigments based on transparent platy substrates, comprising applying a near refractive index coating that is matched to the substrate;
wherein the substrates are selected from the group consisting of mica, glass flakes, SiO₂, AI₂O₃, BiOCI, kaolin, ZnO, BN, perlite and mixtures thereof;
wherein the refractive index of the transparent platy substrates is in the range of from 1.4 to 1.8;
wherein the refractive index of the near refractive index coating is in the range of from 1.4 to 1.8;
wherein the near refractive index coating has a refractive index within 0.0 t0 0.15 of the substrate;
wherein the near refractive index coating has a thickness in the range of from 50 to 150 nm; and
wherein the near refractive index coating consist of two metal oxides A and B, which are mixed to create the near refractive index coating, wherein the refractive index of the near refractive index coating is determined using the following formula n=X_{A}·n_{A}+X_{B}·n_{B}, wherein n is the resulting refractive index of the near refractive index coating; X_{A} is the mole fraction of the metal oxide A; n_{A} is the refractive index of the metal oxide A; X_{B} is the mole fraction of the metal oxide B; and n_{B} is the refractive index of the metal oxide B.

24-34. (canceled)

35. The process of claim 23, further comprising a combination of subsequent optical layers wherein the subsequent optical layers are selected from the group consisting of TiO₂, Fe₂O₃, TiO₂/Fe₂O₃, TiO₂/SiO₂/TiO₂, TiO₂/SiO₂/Fe₂O₃, Fe₂O₃/SiO₂/TiO₂, and Fe₂O₃/SiO₂/Fe₂O₃, preferably the subsequent optical layers are selected from the group consisting of TiO₂ and Fe₂O₃, more preferably the subsequent optical layer comprises, more preferably is a TiO₂ layer.

36-39. (canceled)

40. The process of claim 23, wherein prior to applying additional optical layers, the applied near refractive index coating is calcined.
